(19) United States
(12) Patent Application Publication
(10) Pub. No.: US 2015/0213442 A1
(43) Pub. Date: Jul. 30, 2015

(54) PAYMENT-CARD SYSTEM AND METHOD

(71) Applicant: Steve Gottlieb, Ponce Inlet, FL (US)

(72) Inventor: Steve Gottlieb, Ponce Inlet, FL (US)

(21) Appl. No.: 14/604,793

(22) Filed: Jan. 26, 2015

Related U.S. Application Data
(60) Provisional application No. 61/931,253, filed on Jan. 24, 2014.

(51) Int. Cl. G06Q 20/34; G06Q 30/02

(52) U.S. Cl. CPC G06Q 20/3574; G06Q 20/355; G06Q 30/0226

(57) ABSTRACT

A payment system may include a computer-interface to customize a payment-card. The system may also include user options on the computer-interface to be added to the payment-card including a plurality of rewards-programs. The system may further include visual icons generated by the computer-interface that are carried by the payment-card that indicate which rewards-programs are linked to the payment-card.

### RELATED APPLICATION

This application is based upon, and claims priority to, prior filed copending provisional application Ser. No. 61/931253 filed Jan. 24, 2014, the entire subject matter of which is incorporated herein by reference in its entirety. The copending application and the present application have identical inventorship and ownership.

### BACKGROUND

The embodiments relate to the field of payment systems.

There are many different types of payment systems such as cash, currency, digital currency, credit cards, checks, debit cards, stored-value cards, electronic checks, and/or the like.

### SUMMARY

According to an embodiment, a payment system method may include supplying a computer-interface to customize a payment-card. The method may also include furnishing user options on the computer-interface to be added to the payment-card including a plurality of rewards-programs. The method may further include generating visual icons carried by the payment-card that indicate which rewards-programs are linked to the payment-card.

The method may additionally include stored-value and/or club membership as user options. The method may also include separating the visual icons into sets based upon industry grouping, reward percentage, and/or sales offers.

The method may further include enabling a user to position and/or size the visual icons on the payment-card. The method may additionally include adjusting the rewards program through use of the payment-card only.

The method may also include adjusting the stored-value through use of the payment-card only. The method may further include where the payment-card comprises an electronic profile carried by a processor-based device.

The method may additionally include where the payment-card comprises credit cards, debit cards, electronic checks, and/or stored-value. The method may also include where the computer-interface comprises a website, smartphone, personal computer, laptop computer, and/or tablet computer.

Another aspect is computer readable program codes coupled to tangible non-transitory media to provide a payment system. The computer readable program codes may be configured to cause the program to supply a computer-interface to customize a payment-card; furnish user options on the computer-interface to be added to the payment-card including a plurality of rewards-programs; and generate visual icons carried by the payment-card that indicate which rewards-programs are linked to the payment-card. The computer readable program codes may also include stored-value and club membership as user options.

The computer readable program codes may further separate the visual icons into sets based upon industry grouping, reward percentage, and/or sales offers. The computer readable program codes may additionally enable a user to position and/or size the visual icons on the payment-card.

The computer readable program codes may also adjust the rewards program through use of the payment-card only. The computer readable program codes may further adjust the stored-value through use of the payment-card only.

Another aspect is a payment system that may include a computer-interface to customize a payment-card. The system may also include user options on the computer-interface to be added to the payment-card including a plurality of rewards-programs. The system may further include visual icons generated by the computer-interface that are carried by the payment-card that indicate which rewards-programs are linked to the payment-card.

The system may additionally include where the user options include stored-value and/or club membership. The system may also include where the visual icons are separated into sets based upon industry grouping, reward percentage, and/or sales offers.

The system may further include where the visual icons are positioned and/or sized by the user. The system may additionally include where the rewards program is adjusted through use of the payment-card only.

### BRIEF DESCRIPTION OF THE DRAWINGS

FIG. 1 is a block diagram of a system in accordance with the embodiments.

FIG. 2 is an embodiment of a payment-card generated by the system of FIG. 1.

### DETAILED DESCRIPTION

Embodiments will now be described more fully hereinafter with reference to the accompanying drawings, in which preferred embodiments are shown. Like numbers refer to like elements throughout.

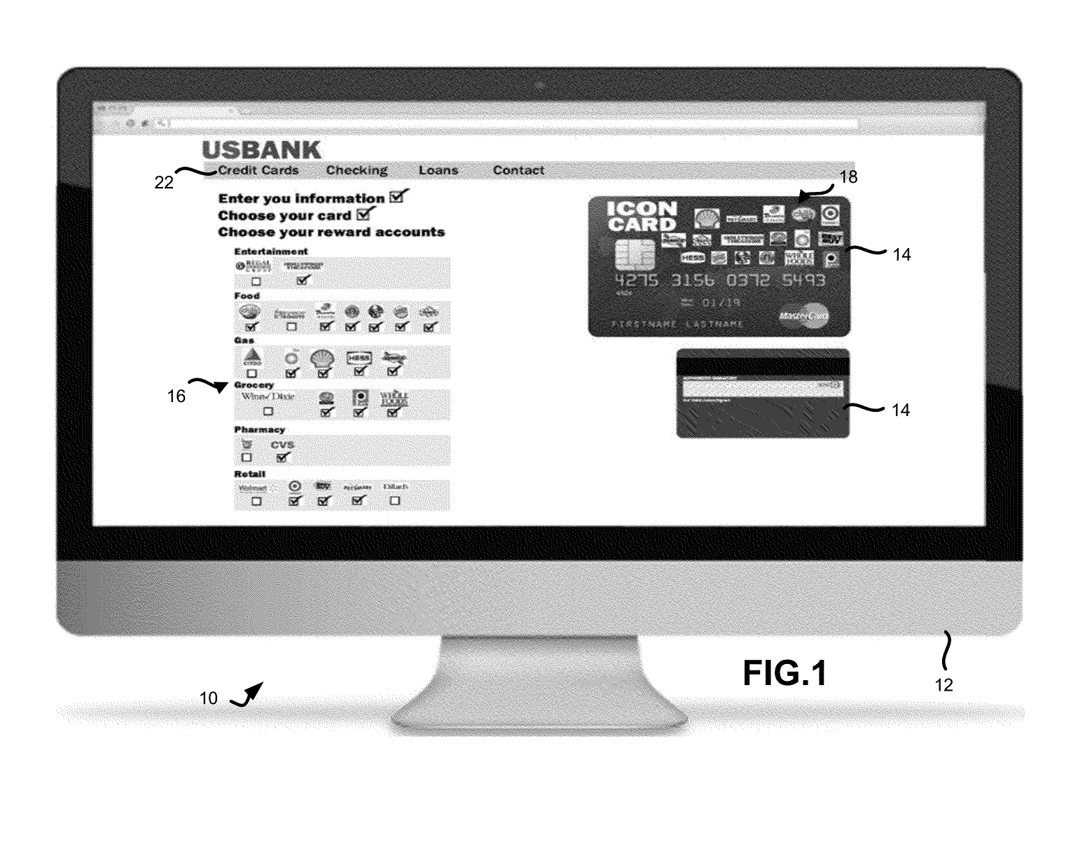

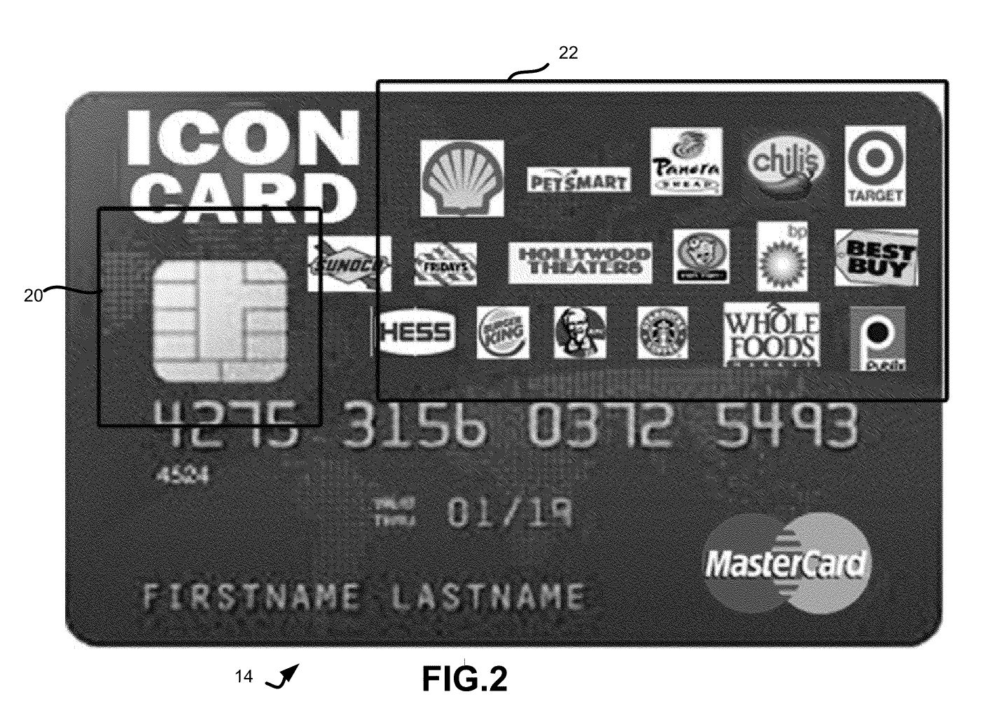

With reference now to FIGS. 1 and 2, a payment system 10 is initially described. In one embodiment, the system 10 includes a computer-interface 12 to customize a payment-card 14. The system 10 also includes user options 16 on the computer-interface to be added to the payment-card 14 including a plurality of rewards-programs. The system 10 further includes visual icons 18 generated by the computer-interface 12 that are carried by the payment-card 14 that indicate which rewards-programs are linked to the payment-card.

In one embodiment, the computer-interface 12 comprises a website, smartphone, personal computer, laptop computer, tablet computer, kiosk interfaces, point-of-sale terminals, computer processors, and/or the like. In another embodiment, the payment-card 14 comprises credit cards, debit cards, electronic checks, stored-value, and/or the like.

In one embodiment, the system 10 additionally includes user options that include stored-value and/or club membership. For example, stored-valued is a retailer's gift card, a pre-paid card, and/or the like. A club membership is a gym membership, automobile club membership, retired person's group membership, and/or the like, for instance.

In one embodiment, the system 10 also includes visual icons 18 that are separated into sets based upon industry grouping, reward percentage, and/or sales offers. In another embodiment, the system 10 further includes the visual icons being positioned and/or sized by the user (not shown).

In one embodiment, the system 10 additionally includes where the rewards program is adjusted through use of the payment-card only. In other words, the rewards program is automatically credited/debited during the payment transaction.

Creating a payment-card is easy. As the user registers for a new or existing card, they are given the option to add the businesses of their choice. During this process the user is asked for existing loyalty information for each business or the option to create a new loyalty account. The new payment-card 14 will arrive with all the icons on the card for each business they chose at signup.

Smart Card Technology 20 can be used to store the individual account numbers for each loyalty account on the payment-card 14, for example. In another embodiment, the payment-card 14 includes printed visual icons 18 for all the businesses selected.

In one embodiment, the system 10 additionally includes where the payment-card 14 comprises an electronic profile 22 carried by a processor-based device such as a website, smartphone, personal computer, laptop computer, tablet computer, kiosk interfaces, point-of-sale terminals, computer processors, and/or the like. Stated another way, the payment-card 14 includes a virtual state as well as a physical state.

A payment system method may include supplying a computer-interface to customize a payment-card. The method may also include furnishing user options on the computer-interface to be added to the payment-card including a plurality of rewards-programs. The method may further include generating visual icons carried by the payment-card that indicate which rewards-programs are linked to the payment-card.

The method may additionally include stored-value and/or club membership as user options. The method may also include separating the visual icons into sets based upon industry grouping, reward percentage, and/or sales offers.

The method may further include enabling a user to position and/or size the visual icons on the payment-card. The method may additionally include adjusting the rewards program through use of the payment-card only.

The method may also include adjusting the stored-value through use of the payment-card only. The method may further include where the payment-card comprises an electronic profile carried by a processor-based device.

The method may additionally include where the payment-card comprises credit cards, debit cards, electronic checks, and/or stored-value. The method may also include where the computer-interface comprises a website, smartphone, personal computer, laptop computer, and/or tablet computer.

Another aspect is computer readable program codes coupled to tangible non-transitory media to provide a payment system. The computer readable program codes may be configured to cause the program to supply a computer-interface to customize a payment-card; furnish user options on the computer-interface to be added to the payment-card including a plurality of rewards-programs; and generate visual icons carried by the payment-card that indicate which rewards-programs are linked to the payment-card. The computer readable program codes may also include stored-value and club membership as user options.

The computer readable program codes may further separate the visual icons into sets based upon industry grouping, reward percentage, and/or sales offers. The computer readable program codes may additionally enable a user to position and/or size the visual icons on the payment-card.

The computer readable program codes may also adjust the rewards program through use of the payment-card only. The computer readable program codes may further adjust the stored-value through use of the payment-card only.

The Icon card, e.g. payment-card 14, is a new style of credit card that combines store rewards cards with one credit card. The Icon Card allows the consumer to go online and sign up for a credit card that enables the consumer to pick their Icons of their favorite merchants. The Icon card will allow up to 30 Icons to be picked and embossed on their personalized Icon card, for example. Everything from fast food to gas purchases can be combined on one card. This eliminates the need to carry the many store rewards cards.

There are a number of consumer advantages. A consumer no longer needs to carry all these cards in your wallet and fumble looking for the right one holding up line. No more wasting time signing up on an individual basis because the consumer can now sign up for 30 at one time, for example. Store discounts automatically applied no questions asked. Merchants compete to offer the consumer the best deal so their Icon gets picked. Faster service while still getting the discount. All on one card instead of two.

There are also merchant advantages. Customer does not hold up the line looking for card. Customer knows immediately if they get discounts by looking at their card. Even fast foods restaurants can now offer discount card without fear of slowing their lines down. The Icon card will encourage repeat business knowing how easy discounts can be obtained. Allows chains as well as local merchants to gain access based on zip codes. Merchant will no longer have to incur the expense of the plastic cards.

There are also credit card company advantages. New revenue source with potential Icon sale to retailers. Increased use of credit card once it comes out of wallet to earn rewards. Consumer driven demand to Icon brand credit card because of consumer convenience. Unique separation from other credit cards on the market.

The Icon card is a revolution for the Credit Card industry. It is a customizable credit card that combines the benefits of a re-wards card and a normal credit card. When the customer applies for this card online they can choose which Icons they want embossed on their card. This gives them the benefits of all of their rewards cards and a credit card all in one convenient card. The average consumer carries 14 rewards cards slowing down lines and creating frustration while digging through a thick wallet searching for the right card. Up to 24 Icons can be embossed right on your credit card so the consumer quickly knows where they get discounts, for example.

Smart technology enables the Icon card. The Icon card provides credit card companies a number of advantages. With most major credit card companies all offering a very similar cash back offer, the Icon card will stand out as a better consumer driven concept. Consumers will love having all rewards on one card instead of a wallet full of clutter. Lines will move faster with one card instead two being presented. Increased use of credit card because of rewards benefit. Allow fast food companies to offer a rewards program without fear of slowing lines. Monthly credit card statement can include rewards totals with potential revenue stream from merchants advertising special offers. Potential revenue stream from merchants once the Icons are established in the market place. Competition among merchants to offer the best rewards so their Icon is picked. Elimination of some competitors as once the Icon card is established the need for airline cards and gas cards will be eliminated. Cards like MA and AARP can have Icons for inclusion in the Icon concept.

The Icon card provides merchant advantages. Quicker lines with combined Credit Card and Rewards card. No expense of supplying cards. Consumers will support their business when hassle free rewards cards are offered. Can tailor rewards program with credit card monthly statement. Allows local merchants to have an inexpensive rewards program that is zip code based upon sign up.

Icon card also provides consumer advantages. One card replaces up to 24 rewards cards, for example. Merchants compete for the best offer so their Icon is picked by the consumer. No fumbling through the wallet looking for the right card. Consumer looks forward to the credit Card bill to see rewards balance and special offers all in one place. No embarrassment using rewards cards.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A business method comprising:
supplying a computer-interface to customize a payment-card;
furnishing user options on the computer-interface to be added to the selected payment-card including a plurality of rewards-programs; and
generating visual icons carried by the payment-card that indicate which rewards-programs are linked to the payment-card.

2. The method of claim 1 further comprising including at least one of stored-value and club membership as user options.

3. The method of claim 1 further comprising separating the icon options into sets based upon at least one of industry grouping, reward percentage, and sales offers.

4. The method of claim 1 further comprising enabling a user to at least one of position and size the visual icons on the payment-card.

5. The method of claim 1 further comprising adjusting the rewards program through use of the payment-card only.

6. The method of claim 1 further comprising adjusting the stored-value through use of the payment-card only.

7. The method of claim 1 wherein the payment-card comprises an electronic profile carried by a processor-based device.

8. The method of claim 1 wherein the payment-card comprises at least one of credit cards, debit cards, electronic checks, and stored-value.

9. The method of claim 1 wherein the computer-interface comprises at least one of a website, smartphone, personal computer, laptop computer, and tablet computer.

10. A computer program product embodied in a tangible non-transitory media comprising:
computer readable program codes coupled to the tangible non-transitory media to provide a canalphone specification, the computer readable program codes configured to cause the program to:
supply a computer-interface to customize a payment-card;
furnish user options on the computer-interface to be added to the payment-card including a plurality of rewards-programs; and
generate visual icons carried by the payment-card that indicate which rewards-programs are linked to the payment-card.

11. The computer program product of claim 10 further comprising program code configured to: include stored-value and club membership as user options.

12. The computer program product of claim 10 further comprising program code configured to: separate the visual icons into sets based upon industry grouping, reward percentage, and/or sales offers.

13. The computer program product of claim 10 further comprising program code configured to: position and/or size the visual icons on the payment-card.

14. The computer program product of claim 10 further comprising program code configured to: adjust the rewards program through use of the payment-card only.

15. The computer program product of claim 10 further comprising program code configured to: adjust the stored-value through use of the payment-card only.

16. A system comprising:
a computer-interface to customize a payment-card;
user options on the computer-interface to be added to the payment-card including a plurality of rewards-programs; and
visual icons generated by the computer-interface that are carried by the payment-card that indicate which rewards-programs are linked to the payment-card.

17. The system of claim 16 wherein where the user options include stored-value and/or club membership.

18. The system of claim 16 wherein wherein the payment-card comprises an electronic profile carried by a processor-based device.

19. The system of claim 16 wherein the visual icons are positioned and/or sized by a user.

20. The system of claim 16 wherein the rewards program is adjusted through use of the payment-card only.
